(19) United States
(12) Patent Application Publication
(10) Pub. No.: US 2026/0214450 A1
(43) Pub. Date: Jul. 23, 2026

(54) System and method for detecting indicators of network attack and removing malicious code

(71) Applicant: Bank of America Corporation, Charlotte, NC (US)

(72) Inventors: Sivashalini Sivajothi, Chennai (IN); Maneesh Kumar Sethia, Hyderabad (IN); Boddu Vikas Teja, Hyderabad (IN); Sunil Krishna Tatavarthi, Hyderabad (IN); Priya Narayanrao Naik, Hyderabad (IN)

(21) Appl. No.: 19/034,089

(22) Filed: Jan. 22, 2025

(51) Int. Cl. H04W 12/122; H04W 12/47

(52) U.S. Cl. CPC H04W 12/122; H04W 12/47

(57) ABSTRACT

A system for detection of a malicious tag within a token request generated in response to a wireless interaction between a user device and a terminal device comprises a memory operable to store a generative artificial intelligence (AI) model and an indicator of attack (IOA) database. The processor is operably coupled to the memory and configured to receive a token request. The token request comprises one or more tags and each of the one or more tags provides information related to the interaction. Based at least in part upon a comparison, determine whether the one or more tags included within the token request comprise a malicious tag. In response to determining that the malicious tag is a removable malicious tag, modify the token request to remove the malicious tag from the token request to generate a sanitized token request.

### TECHNICAL FIELD

The present disclosure relates generally to network and device security and, more specifically, to a system and method for detecting indicators of network attack and removing malicious code.

### BACKGROUND

In a network environment, user devices are in data communication with terminal devices. These network environments allow wireless interaction between the user and terminal devices. Some of the technical challenges that occur when data is exchanged as part of the wireless interaction are controlling unauthorized access to data and preventing malicious activities. Additionally, authentication of the wireless interaction poses several network security challenges, including preventing malicious activities, such as malware attacks. Existing systems are unable to detect or mitigate certain malware attacks before an attack. Existing systems rely on system failure reports to detect the malicious attack after the attack. Hence, by the time these failure reports are received, the attack has done at least some of its intended damage.

### SUMMARY

The system and method implemented by the system, as disclosed in the present disclosure, provide technical solutions to the technical problems discussed above by proactively identifying malicious code (malicious attack) within a request generated in response to a wireless interaction between a user device and a terminal device. Further, the system reconstructs the request to eliminate the malicious code and thus mitigate the malicious attack to avoid damage (e.g., server damage, compromised computing performance, device failure, etc.) to computing systems.

For a wireless (e.g., near field communication (NFC) channel) interaction performed between a user device and a terminal device, the most common malicious attack method is a man-in-the-middle (MITM) attack. In MITM attacks, interactions between the user device and the terminal device are intercepted. These malicious attacks typically occur because the user device is compromised and/or a terminal device is compromised by malware attacks, causing the data exchanged as part of the interaction also to be compromised. Specifically, a request is generated in response to a wireless interaction between a user device and a terminal device, and these requests are intercepted by bad actors that may inject malicious code into the request as part of the malicious attack. In one example, a malicious attack may include the unauthorized installation of malware at a computing device (e.g., a server device that processes the request), wherein the malware (malicious code) is configured to perform malicious activities to disrupt an operation of the computing device, for example, by creating unwanted files to slow down the speed and performance of the computing device, corrupting files, or crashing some software or executable applications so that they cannot be executed. Malware attacks can infect many types of computing devices in a network environment (e.g., database servers, email servers, application servers, etc.). It usually spreads by duplicating itself and hiding in a device's data files. A malware attack often results in compromised computing performance by causing slow processor performance, and data redirects, frequent infection warnings, problems starting up and shutting down a computing node, sudden loss of memory disk space, repeated system crashes and freezes, disabled security features, changes in a file name and sizes, programs opening and closing themselves, or a combination thereof. In some cases, malware attacks can lock up networks and computing nodes, making them unusable. In another example, malware attacks may include access to sensitive data, such as personal information, without authorization. In another example, a malware attack may exfiltrate data by transmitting confidential data to unauthorized devices. In some cases, the stolen data may be used to perform other unauthorized data interactions within the computing infrastructure and to gain access to other computing nodes and cause damage (e.g., data theft, compromised computing performance, device failure etc.) to those other computing nodes.

The current malicious attack detection techniques suffer from several drawbacks in detecting such attacks. For example, the current malicious attack detection techniques cannot detect malicious attacks before the attack has done its intended damage. The current malicious attack detection techniques rely on system failure reports to detect the malicious attack after the attack. By the time these failure reports are received, the attack has done its intended damage. Thus, the current malicious attack detection techniques are retroactive - meaning that the attack is detected after it has done its intended damage. Additionally, the current malicious attack detection techniques cannot eliminate the malicious code within the request.

Embodiments of the present disclosure provide several practical applications and technical advantages that provide solutions to the problems discussed above in relation to conventional computing systems and networks.

For example, the disclosed system and methods provide the practical application of proactively identifying malicious code within a request generated in response to a wireless interaction between a user device and a terminal device. Further, the system applies remediation methods, such as reconstructing the request to eliminate the malicious code and thus mitigate the malicious attack to avoid damage (e.g., server damage, compromised computing performance, device failure, etc.) to computing infrastructure because of the malware attack.

### Receive a Token Request and Extract Tags

As described in embodiments of the present disclosure, a server device may be configured to proactively identify malicious code within a request generated in response to a wireless interaction between a user device and a terminal device. For example, the server device may be configured to receive a token request in response to an interaction initiated between a user device and a terminal device. The token request comprises a plurality of tags, and each tag provides information related to the interaction. For example, the tags may include a terminal identifier, a card number, a device identifier, an operating system identifier, or any other tag that provides information related to the wireless interaction. The server device is further configured to extract the tags included within the token request by utilizing an AI algorithm (e.g., a Naïve Bayes classification algorithm) that is trained to extract tags included within the token request.

### Compare the Extracted Tags With Existing Indicators of Attack to Determine a Malicious Tag

The server device compares the extracted tags with a list of existing indicators of attack stored in an indicator of attack (IOA) database. Each of the existing indicators of attack stored in the IOA database may include an example of malicious code associated with a malicious attack. The extracted tags within the token request are compared with the existing indicators of attack to determine if at least one of the tags includes malicious code that matches at least one of the malicious codes in the existing indicators of attack. Based on the comparison, if a tag includes a malicious code that matches the malicious code in the existing indicators of attack, then the tag is determined as a malicious tag.

### Determine if the Malicious Tag is a Removable Malicious Tag or an Unremovable Malicious Tag

In response to determining that the tags included within the token request includes a malicious tag, the server device determines whether the malicious tag is a removable malicious tag or an unremovable malicious tag. A removable malicious tag is a tag within the token request that is not essential or not mandatory to authenticate the wireless interaction. For example, a device identifier and an operating system identifier, when included in the token request, are determined as removable tags as they are not essential to authenticate the wireless interaction. An unremovable tag is that tag within the token request, which is essential or mandatory to authenticate the wireless interaction. For example, the terminal identifier and the card number when included within the token request are determined as unremovable tags as they are essential to authenticate the wireless interaction.

### When the Malicious Tag is Determined as a Removable Malicious Tag, Generate a Sanitized Token Request

In response to determining that the malicious tag is a removable malicious tag, the server device modifies the token request to remove the malicious tag from the token request to generate a sanitized token request. Additionally, the server device includes the removable malicious tag in a list of AI-determined indicators of attack stored in the IOA database. The server device then approves sanitized token request.

Thus, unlike conventional systems where a malicious attack is detected after damage to computing systems has taken place, the disclosed system and methods proactively detect a malicious attack and implement remediation methods that stop damage or further damage from occurring because of the malicious attack. For example, as disclosed in embodiments of the present disclosure, the server device is configured to determine a malicious code within the token request and then eliminate the malicious code to generate a sanitized token request without the malicious code. Thus, eliminating the malicious code results in avoiding damage to the server device that processes the token request in order to authenticate the wireless interaction. By eliminating the malicious attack, bad actors are restricted from gaining access to the server device and from installing malware on the server device. By avoiding a malware attack on the server device, the disclosed system and method mitigate damage to the server device that may otherwise occur due to malware being installed on the server device. For example, avoiding a malware attack may avoid several types of damage typically caused by a malware attack, including, but not limited to, compromised computing performance, including slow processor performance, data redirects, frequent infection warnings, problems starting up and shutting down a computing node, sudden loss of memory disk space, repeated system crashes and freezes, disabled security features, changes in file name and sizes, programs opening and closing themselves, or a combination thereof. In addition, by eliminating malicious attacks, there is no unauthorized access to the server device. The disclosed system and method thus avoid or restrict a bad actor from gaining unauthorized access to other computing nodes and systems that are communicatively coupled to the server device and thus avoid damage to those other computing nodes and systems. Thus, by avoiding malware attacks on computing nodes and systems, the disclosed system and methods improve performance of those computing nodes and systems.

In another example, the server device may be configured to quarantine the token request at a quarantine sector within the memory of the server device as soon as it receives the token request generated in response to an interaction initiated between a user device and a terminal device. Once the token request is quarantined in the quarantine sector, the server device performs the above-explained operations (within the quarantine sector) of identifying a malicious code in the token request and eliminating the malicious tag to generate a sanitized token request. Accordingly, the quarantine sector is a memory sector created by the disclosed system such that software programs, software applications, or any request stored in this quarantine sector is not permitted or restricted from acting on files outside the quarantine sector. Thus, any malicious file isolated in the quarantine sector cannot harm or attack the rest of the components outside the quarantine sector. The disclosed system mitigates the malicious attack by eliminating the malicious code to generate a sanitized token request and, in response, approves the authentication of the wireless interaction. This sanitized token request is also referred to as a modified token request. In this manner, malware attacks are mitigated by physically isolating the token request in the quarantine sector and proactively deleting the malicious code from that token request to create a sanitized version of the token request. Thus, by isolating malware attacks within a quarantine sector, the security of the server devices and information stored in the server device is not compromised.

Thus, the disclosed system and method generally improve the technology associated with data security of computing networks.

In some embodiments, a system for detection of a malicious tag within a token request generated in response to a wireless interaction between a user device and a terminal device comprises a memory operable to store a generative artificial intelligence (AI) model and an indicator of attack (IOA) database. The IOA database includes one or more existing indicators of attack and one or more AI-determined indicators of attack. The processor operably coupled to the memory and configured to receive a token request in response to an interaction initiated between a user device and a terminal device. The token request comprises one or more tags, and each of the one or more tags provides information related to the interaction. The processor is further configured to execute the generative AI model to extract the one or more tags included within the token request and compare the extracted one or more tags with the one or more existing indicators of attack stored in the IOA database. The generative AI model determines whether the one or more tags included within the token request comprise a malicious tag based at least in part upon the comparison. The generative AI model determines whether the malicious tag is a removable malicious tag or an unremovable malicious tag in response to determining that the one or more tags included within the token request comprises a malicious tag. The generative AI model modifies the token request to remove the malicious tag from the token request to generate a sanitized token request in response to determining that the malicious tag is a removable malicious tag. The generative AI model approves the sanitized token request.

In some embodiments, a system for detection of a malicious tag within a token request generated in response to a wireless interaction between a user device and a terminal device comprises a memory operable to store an indicator of attack (IOA) database. The IOA database includes one or more existing indicators of attack and one or more AI-determined indicators of attack. A processor operably coupled to the memory and configured to receive a token request in response to an interaction initiated between a user device and a terminal device. The token request comprises one or more tags, and each of the one or more tags provides information related to the interaction. The processor is further configured to extract the one or more tags included within the token request and compare the extracted one or more tags with the one or more existing indicators of attack stored in the IOA database. The processor is further configured to based at least in part upon the comparison, determine whether the one or more tags included within the token request comprise a malicious tag. The processor is further configured to in response to determining that the one or more tags included within the token request comprises a malicious tag, determine whether the malicious tag is a removable malicious tag or an unremovable malicious tag. The processor is further configured to in response to determining that the malicious tag is a removable malicious tag, modify the token request to remove the malicious tag from the token request to generate a sanitized token request. The processor is further configured to include the removable malicious tag in the one or more AI-determined indicators of attack stored in the IOA database and approve the sanitized token request.

In this manner, the disclosed system improves the accuracy of identifying malicious tags within a token request based on indicators of attack and mitigating the malicious attack by reconstructing the token request to eliminate the malicious attack. The disclosed system is an ongoing process of identifying malware attacks and mitigating these attacks before an interaction, which improves the efficiency of the disclosed system.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with an embodiment of the present disclosure;

FIG. 2A illustrates a first token request of FIG. 1, including a removable malicious tag, in accordance with one or more embodiments of the present disclosure;

FIG. 2B illustrates a first sanitized token request, in accordance with one or more embodiments of the present disclosure;

FIG. 2C illustrates a first token request of FIG. 1, including an unremovable malicious tag, in accordance with one or more embodiments of the present disclosure;

FIG. 3A illustrates existing indicators of attack of FIG. 1, in accordance with one or more embodiments of the present disclosure;

FIG. 3B illustrates AI determined indicators of attack of FIG. 1, in accordance with one or more embodiments of the present disclosure;

FIG. 4A illustrates a second token request of FIG. 1, including a removable malicious tag, in accordance with one or more embodiments of the present disclosure;

FIG. 4B illustrates a second sanitized token request, in accordance with one or more embodiments of the present disclosure;

FIG. 4C illustrates a second token request of FIG. 1, including an unremovable malicious tag, in accordance with one or more embodiments of the present disclosure;

FIG. 5 illustrates an example flowchart of a method of the system of FIG. 1 for detecting a malicious tag within a first token request based on existing indicators of attack, in accordance with one or more embodiments of the present disclosure; and

FIG. 6 illustrates an example flowchart of a method of the system of FIG. 1 for detecting a malicious tag within a second token request based on AI-determined indicators of attack, in accordance with one or more embodiments of the present disclosure.

### DETAILED DESCRIPTION

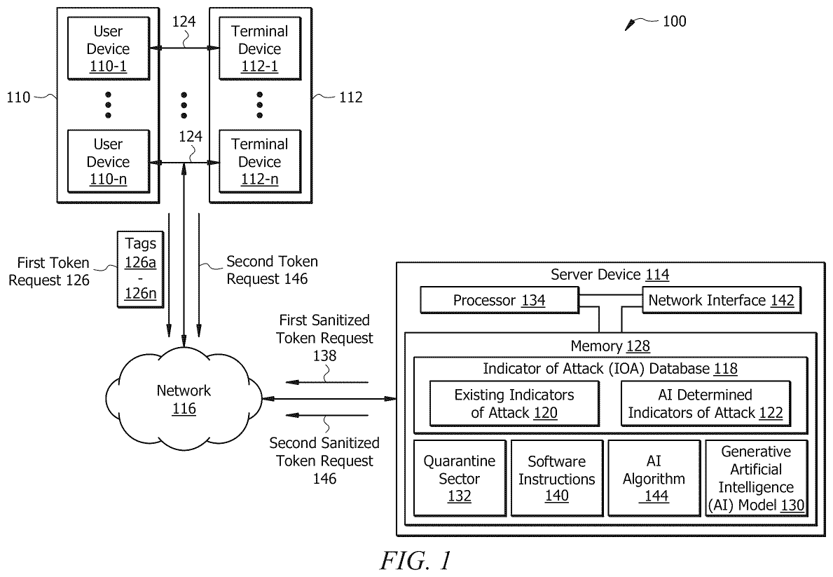

As described above, previous technologies fail to identify malicious attacks before an attack. Embodiments of the present disclosure and its advantages may be understood by referring to FIGS. 1-6. FIGS. 1-6 are used to describe systems and methods for detecting a malicious attack based on indicators of network attack and removing malicious code to mitigate the attack, according to some embodiments.

### System Overview

FIG. 1 is a schematic diagram of a system 100, in accordance with certain aspects of the present disclosure. As shown, system 100 includes user devices 110-1 to 110-n, terminal devices 112-1 to 112-n, and a server device 114, operably connected to one another via a network 116. Network 116 enables communication among the components of the system 100. The user devices 110-1 to 110-n are collectively referred to as user device 110. The terminal devices 112-1 to 112-n are collectively referred to as terminal device 112.

In general, system 100 improves the mitigation of malicious attacks to authenticate wireless interactions 124 by proactively detecting malicious tags by utilizing the indicator of attack (IOA) database 118. The IOA database 118 includes existing indicators of attack 120 and AI-determined indicators of attack 122.

### System Components

### Network

Network 116 may be any suitable type of wireless and/or wired network. The network 116 may be connected to the Internet or public network. Network 116 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wireless Fidelity (WiFi®), Wireless Gigabit (WiGig®), Worldwide Interoperability for Microwave Access (WiMAX®), etc.), a long-term evolution (LTE) network, a universal mobile telecommunications system (UMTS) network, a peer-to-peer (P2P) network, a Bluetooth® network, a near-field communication (NFC) network, and/or any other suitable network. The network 116 may be configured to support any suitable type of communication protocol, as would be appreciated by one of ordinary skills in the art.

### User Device

System 100 includes user devices 110-1 to 110-n, these are collectively referred to as user device 110. The user devices 110-1 to 110-n may generally be any device configured to process data. User devices 110-1 to 110-n may also include but are not limited to, a personal computer, a desktop computer, a workstation, a server, a laptop, a tablet computer, a mobile phone (such as a smartphone), an Internet-of-Things (IoT) device, a wearable computing device, smart glasses, smart watches or bracelets, phablets, other smart devices, devices configured for wired or wireless RF (Radio Frequency) communication, or any other suitable type of device. The user devices 110-1 to 110-n may include a user interface, such as a display, a microphone, a camera, a keypad, or other appropriate equipment usable by a user. User devices 110-1 to 110-n are utilized to perform wireless interaction 124 with terminal devices 112-1 to 112-n.

### Terminal Device

System 100 includes terminal devices 112-1 to 112-n, these are collectively referred to as terminal device 112. The terminal devices 112-1 to 112-n may generally be any wired and/or wireless device configured to transmit/receive radio signals using NFC®, Bluetooth®, dedicated short-range communications (DSRC®), RFID®, universal serial bus (USB®), Wi-Fi®, etc. Terminal devices 112-1 to 112-n may also include but are not limited to, a card reader device, an automated teller machine (ATM), a point of sale (POS) device, a personal computer, a desktop computer, a workstation, a laptop, a tablet computer, a mobile phone (such as a smartphone), an Internet-of-Things (IoT) device, or any other suitable type of device. The terminal devices 112-1 to 112-n may include a user interface, such as a display, a microphone, a camera, a keypad, or other appropriate terminal equipment usable by a user. Terminal devices 112-1 to 112-n are utilized to perform wireless interaction 124 with user devices 110-1 to 110-n.

### Wireless Interaction

User devices 110-1 to 110-n are utilized to perform wireless interaction 124 with terminal devices 112-1 to 112-n. For example, wireless interaction 124 may be a near-field communication (NFC) channel interaction 124 that involves data exchanges between, for example, an NFC-enabled user device 110-1 and an NFC-enabled terminal device 112-1 to generate first token request 126. Wireless interaction 124 may also include short-range communication links and very short-range communication links.

A short-range communication link may be a communication link between user devices 110-1 to 110-n and terminal devices 112-1 to 112-n where data is transmitted via a wired and/or wireless connection within a first threshold distance (e.g., 30 feet, 50 feet, 100 feet, 200 feet, etc.). For example, a short-range communication link may include Bluetooth®, DSRC®, RFID®, Wi-Fi®, USB®, etc. A very short-range communication link may be a communication link between devices where data is transmitted via a wired and/or wireless connection within a second threshold distance which is less than the first threshold distance (e.g., one inch, three inches, six inches, a foot, three feet, etc.). For example, a very short-range communication link may include NFC®, high-frequency radio frequency identification (HF RFID®), etc. In some scenarios, very short-range communication links may also be short-range communication links.

Additionally, wireless interaction may also include other communication methods such as a Zigbee® interaction, a Z-wave® interaction, although any other wireless form of communication may also be included.

### Token Request and Tags

A wireless interaction 124 involves data exchanges between, for example, a user device 110-1 and a terminal device 112-1 to generate first token request 126. A wireless interaction 124 is performed between user device 110 and terminal device 112. For example, wireless interaction 124 may be a near-field communication (NFC) channel interaction 124 that involves data exchanges between, for example, an NFC-enabled user device 110-1 and an NFC-enabled terminal device 112-1 to generate a first token request 126.

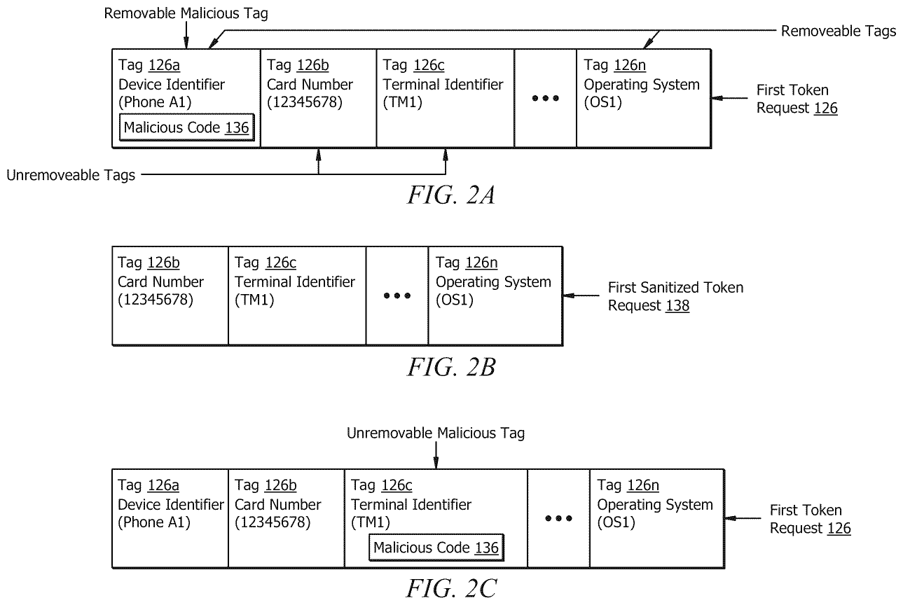

The first token request 126 (with reference to FIG. 2A) includes multiple tags (e.g., Tag-126a, Tag-126b, Tag-126c, . . . , Tag-126n). Each of these tags 126a-126n provides information related to the wireless interaction 124 (i.e., NFC interaction). For example, tag 126a may include a device identifier (e.g., Phone A1) associated with the user device 110-1, tag 126b may include a card number associated (e.g., 12345678) with a user of the user device 110-1, 126c may include a terminal identifier (e.g., TM1) associated with the terminal device 110-1, tag 126n may include an operating system (e.g., OS1) identifier associated with the user device 110-n, or any other tag may also be included that provides information related to the NFC interaction 124. First token request 126 is then transmitted to a server device 114 for authentication.

In some embodiments, first token request 126 may also include financial data for a financial card, user profile information, merchant profile information, user account information, merchant account information, and/or user login information. First token request 126 may be generated in response to a tap of a user device 110-1 on the terminal device 112-1. For example, first token request 126 may represent financial data for a selected financial card associated with a user of the user device 110-1 that may be transmitted to terminal device 112-1 (in response to a tap interaction) at an establishment where the user of user device 110-1 is making a purchase.

### Server Device

The server device 114 includes a processor 134 in signal communication with a memory 128. Memory 128 stores software instructions 140 that when executed by processor 134, cause processor 134 to perform one or more operations of the server device 114 described herein. The operations performed by the processor 134 generally include a hardware computer system generally configured to include proactively and retroactively detecting malicious tags and eliminating malicious attacks before an attack. In some embodiments, the server device 114 may be implemented by a cluster of computing devices, such as virtual machines. For example, the server device 114 may be implemented by a plurality of computing devices using distributed computing and/or cloud computing systems in a network. In some embodiments, the server device 114 may be one or more servers in a server farm. In some embodiments, the server device 114 may include one or more servers in one or more data centers, data warehouses, and the like. The server device 114 may be an instance of one or more servers. In some embodiments, the server device 114 may be configured to provide services and resources (e.g., data and/or hardware resources) to the components of the system 100. Processor 134 of the server device 114 may determine if at least one of the tags 126a-126n within the first token request 126 includes a malicious code based on accessing a list of existing indicators of attack 120 stored in the IOA database 118. Processor 134 of the server device 114 is configured to modify the first token request 126 by removing a malicious tag to generate a first sanitized token request 138 (without malware) and approve the wireless interaction 124.

### Network Interface

Network interface 142 is configured to enable wired and/or wireless communications. The network interface 142 may be configured to communicate data between the server device 114 and user devices 110-1 to 110- n, terminal devices 112-1 to 112-n, and other systems, domains, or devices. For example, the network interface 142 may include an NFC interface, a Bluetooth® interface, a Zigbee® interface, a Z-wave® interface, a radio-frequency identification (RFID®) interface, a WIFI® interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 134 may be configured to send and receive data using the network interface 142. The network interface 142 may be configured to use any suitable type of communication protocol.

### Memory

The memory 128 may be volatile or non-volatile and may comprise read-only memory (ROM), random-access memory (RAM), ternary content-addressable memory (TCAM), dynamic random-access memory (DRAM), and static random-access memory (SRAM). The memory 128 may include one or more of a local database, a cloud database, a network-attached storage (NAS), etc. The memory 128 comprises one or more disks, tape drives, or solid-state drives, and may be used as an over-flow data storage device, to store programs when such programs are selected for execution, and to store instructions and data that are read during program execution. The memory 128 may store any of the information described in FIGS. 1-6 along with any other data, instructions, logic, rules, or code operable to implement the function(s) described herein when executed by processor 134. For example, the memory 128 may store an indicator of attack (IOA) database 118, software instructions 140, generative AI model 130, artificial intelligence (AI) algorithm 144, quarantine sector 132, and/or any other data or instructions. The software instructions 140 may include any suitable set of instructions, logic, rules, or code operable to execute the processor 134 and perform the functions described herein, such as some or all of those described in FIGS. 1-6.

### Generative Artificial Intelligence (AI) Model and AI Algorithm

Memory 128 stores generative AI model 130, and processor 134 may use an AI algorithm 144 (e.g., at least one machine learning, neural network, or deep learning algorithm) to generate the generative AI model 130. Processor 134 executes software instructions 140 to implement the generative AI model 130 and is generally configured to perform one or more operations associated with detecting malicious tags and eliminating malicious attacks.

The AI algorithm 144 may include a support vector machine, machine learning, neural network, random forest, deep learning algorithm, k-means clustering, Tree-based algorithm, Random Forest algorithm, convolutional neural network (CNN), deep neural network (DNN), recurrent neural network (RNN), Naïve Bayes classification, etc. In some embodiments, the AI algorithm 144 may include a data processing machine learning algorithm that is configured to perform one or more operations associated with detecting malicious tags and eliminating malicious attacks. The AI algorithm 144 may be implemented by supervised, semi-supervised, and/or unsupervised machine learning.

In some embodiments, processor 134 trains the AI algorithm 144 to generate the generative AI model 138, and processor 134 executes the generative AI model 138 to perform one or more operations associated with detecting malicious tags and eliminating malicious attacks.

Specifically, AI algorithm 144 can be trained based on two sets of training data. The first set of training data includes data labeled with malicious tags (i.e., tags including malicious codes), and the second set of training data includes data labeled with clean tags (i.e., tags without malicious codes). The AI algorithm 144 is thus trained to distinguish and identify malicious tags from clean tags based on the two sets of training data. Additionally, the first set of training data may be labeled for a plurality of classes of malware, such that AI algorithm 144 is trained to distinguish a malicious tag belonging to a specific class of malware. For example, the first set of training data labels a malicious tag with its corresponding malware class (e.g., Trojan horse programs). In the embodiment of the present invention, the plurality of classes of malware may include Adware, Backdoor programs, Trojan horse programs, destructive computer viruses, worm viruses, and/or Rootkit. Further, AI algorithm 144 may also be trained to identify any other type of malware.

In another embodiment, the processor 134 executes the AI algorithm 144 to perform one or more operations associated with detecting malicious tags and eliminating malicious attacks without utilizing the generative AI model 130.

In another embodiment, the processor 134 executes software instructions 140 and is configured to perform one or more operations associated with detecting malicious tags and eliminating malicious attacks without utilizing the generative AI model 130.

### Processor

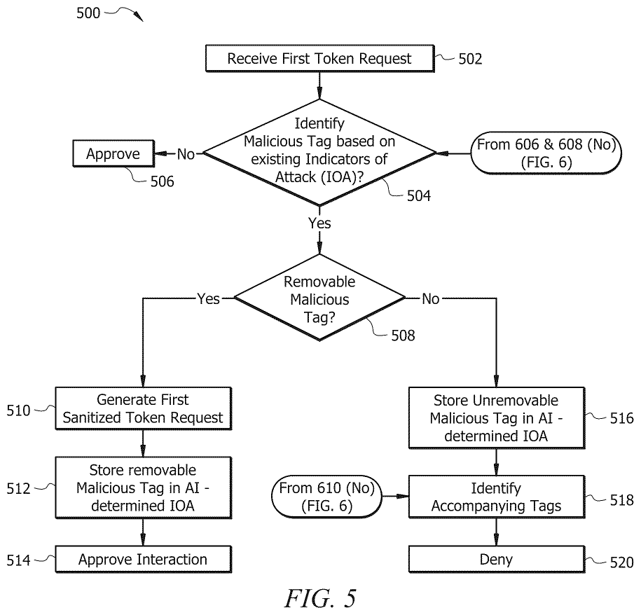

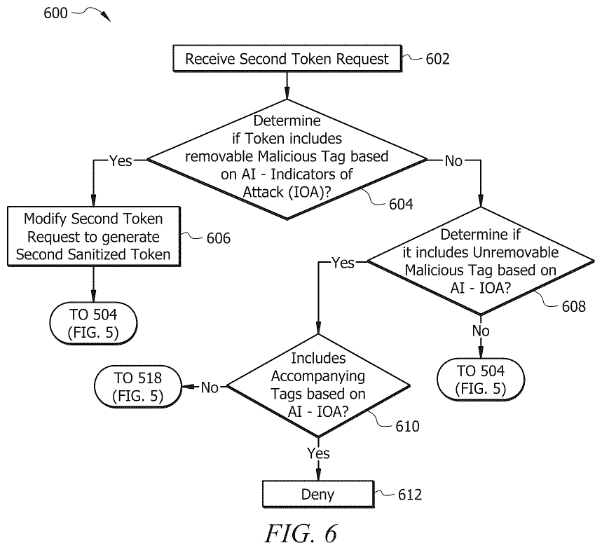

The server device 114 includes processor 134 that is operably coupled with memory 128 and network interface 142. Processor 134 includes one or more processors. Processor 134 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. Processor 134 may be a programmable logic device, a microcontroller, a microprocessor, or any suitable number and combination of the preceding. The one or more processors are configured to process data and may be implemented in hardware or software. For example, the processor 134 may be 8-bit, 16-bit, 32-bit, 64-bit, or of any other suitable architecture. The processor 134 may include an arithmetic logic unit (ALU) for performing arithmetic and logic operations. The processor 134 may register the supply operands to the ALU and store the results of ALU operations. Processor 134 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 140) to perform the operations of the server device 114 described herein. In this way, processor 134 may be a special-purpose computer designed to implement the functions disclosed herein. In an embodiment, the processor 134 is implemented using logic units, FPGAs, ASICs, DSPs, or any other suitable hardware. The processor 134 is configured to operate as described in FIGS. 1-6. For example, processor 134 may be configured to perform one or more operations of the operational flow 500, as described in FIG. 5, and operational flow 600, as described in FIG. 6. In some embodiments, the processor 134 executes software instructions 140 to perform one or more operations associated with detecting malicious tags and eliminating malicious attacks.

### Receive a First Token Request and Extract Tags

The processor 134 of the server device 114 receives the first token request 126 (see FIG. 2A) for authentication in response to a wireless interaction 124 initiated or performed between user device 110-1 and the terminal device 112-1. The processor 134 stores memory 128, and the memory 128 includes a generative artificial intelligence (AI) model 130 and an AI algorithm 144. The processor 134 executes the generative AI model 130 to extract the tags 126a to 126n included within the first token request 126. The generative AI model 138 is trained based on the AI algorithm 144 (e.g., a Naïve Bayes classification algorithm) to extract tags included within the first token request 126.

### Compare the Extracted Tags With Existing Indicators of Attack to Determine a Malicious Tag

The processor 134 compares the extracted tags 126a to 126n with a list of existing indicators of attack 120 stored in an indicator of attack (IOA) database 118 to determine if at least one of the received tags 126a-126n includes malicious code that at least partially matches with the example of the malicious code stored in the existing indicators of attack 120.

### Existing Indicators of Attack

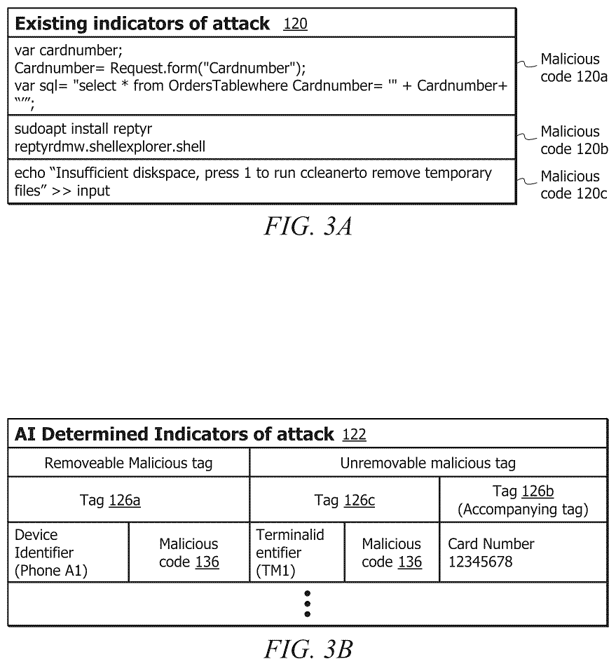

Existing indicators of attack 120 (see FIG. 3A) include a list of indicators corresponding to a malware attack. The list of indicators may include any information utilized to determine a malware attack. Each of the existing indicators of attack 120 stored in the IOA database 118 may include an example of malicious code associated with a malicious attack. FIG. 3A is an example of a list of indicators included within the existing indicators of attack 120. FIG. 3A shows the list of indicators, including malicious code 120a, malicious code 120b, and malicious code 120c. Further, malicious codes 120a-120c each represent malicious code associated with a malware attack. The malicious code represents a software code associated with performing malicious activities. For example, the malicious code 120a may be an SQL injection code associated with an SQL injection attack, malicious code 120b is a software code associated with downloading malicious software as part of a malicious attack, and malicious code 120c is a software code associated with executing a malicious software as part of a malicious attack, or any other form of software code associated with malicious activities may also be included. The malicious software may include a malware, a virus, a trojan horse, a macro virus, a ransomware, a spyware, an adware, a scareware, a rootkit, or a combination thereof.

With reference to FIG. 2A, based on comparing the extracted tags 126a to 126n with a list of existing indicators of attack 120, for example, if tag 126a includes a malicious code 136 that matches the malicious code 120a in the existing indicators of attack 120, then tag 126a is determined as a malicious tag. Accordingly, tag 126a is referred to as malicious tag 126a. By way of example, a malicious code 136 associated with a malicious attack is a system query language (SQL) injection code associated with an SQL injection attack injected in tag 126a. An SQL injection attack is an example of a malicious attack where a code injection technique is utilized to inject malicious SQL statements in tag 126a to attack the operations of server device 114. Upon receiving the first token request 126, processor 134 accesses the existing indicators of attack 120 to determine if the tags 126a-126n in the token request 126 include a malicious code that at least partially matches the malicious codes 120a, 120b, and/or 120c. For example, upon determining that a malicious code 136 matches the example malicious code 120a, then tag 126a is determined as a malicious tag 126a.

In another embodiment, with reference to FIG. 2C, based on comparing the extracted tags 126a to 126n with a list of existing indicators of attack 120, for example, if tag 126c within the token request 126 includes a malicious code 136 that matches the malicious code 120a in the existing indicators of attack 120, then tag 126c is determined as a malicious tag, and accordingly, tag 126c is referred to as malicious tag 126c.

### Additional Examples of Existing Indicators of Attack

### 1: Existing Indicators of Attack, Including Unregistered Tags

Other examples of the stored list of existing indicators of attack 120 may include identifying an unregistered tag included in the first token request 126. Identifying a tag as an unregistered tag may be performed based on device identifiers and/or terminal identifiers.

For example, with reference FIG. 2A, tag 126a may be an unregistered tag, which includes an unregistered device identifier (e.g., Phone A1). Unregistered device identifiers are those device identifiers that are not part of a list of registered device identifiers previously stored in memory 128 of the server device 114. The list of registered device identifiers includes device identifiers that are trusted (i.e., not malicious) by the server device 114. For example, when server device 114 receives a token request 126, including, for example, a device identifier (e.g., Phone A1) in tag 126a that is not part of the list of registered device identifiers, then tag 126a would be determined as a malicious tag 126a.

In another embodiment, for example, with reference FIG. 2C, an unregistered tag may be tag 126c, which includes an unregistered terminal identifier (e.g., TM1). The stored list of existing indicators of attack 120 may include identifying an unregistered tag based on an unregistered terminal identifier. As explained above, with reference to unregistered device identifiers, for example, when server device 114 receives the first token request 126, including tag 126c with a terminal identifier (e.g., TM1) that is not part of the list of registered terminal identifiers, then tag 126c is determined as a malicious tag.

### 2: Existing Indicators of Attack, Including Tags That are Frequently Suspectable to Malware Attacks

Another example of the stored list of existing indicators of attack 120 may include a tag (e.g., a tag 126a including device identifier) that is frequently suspectable to malware attacks.

For example, with reference FIG. 2A, the processor 134 of the server device 114 monitors, over a period of time, a plurality of wireless interactions 124 performed between user devices 110-1 to 110-n and corresponding terminal devices 112-1 to 112-n. Based on the monitoring, server device 114 determines the number of times a device identifier in a tag (e.g., device identifier in tag 126a) has been identified as a malicious tag based on determining a malicious code 136 within it (as part of the comparison explained above). For example, upon determining that the device identifier (e.g., Phone A1) in tag 126a has been affected and identified as a malicious tag over a threshold number of times, it identifies that the tag 126a (e.g., Phone A1) is frequently suspectable to malicious attacks and hence includes the device identifier of Phone A1 as a malicious tag in the existing indicators of attack 120. Similar to a device identifier that is frequently suspectable to malware attacks, the stored list of existing indicators of attack 120 may include a terminal identifier (e.g., TM1 of tag 126c with reference FIG. 2C) that is frequently suspectable to malware attacks.

Other examples of the stored list of existing indicators of attack 120 may include an operating system identifier tag (e.g., a software version) with a bug that causes the operating system to be frequently suspectable to malware attacks. For example, with reference FIG. 2A, a tag 126n includes an operating system identifier (e.g., OS1). In response to receiving the first token request 126, server device 114 accesses a stored list of vulnerable operating system identifiers previously stored in memory 128 of the server device 114. The list of vulnerable operating system identifiers includes operating system identifiers that are not trusted (i.e., include bugs) by the server device 114. For example, when server device 114 receives the first token request 126, including, for example, an operating system identifier (e.g., OS1) in tag 126n that is not part of the list of vulnerable operating system identifiers, then tag 126n would be determined as a malicious tag 126n. Although any other type of indicator of attack associated with wireless interactions between user devices 110 and terminal devices 112 may also be included.

### Determine if the Malicious Tag is a Removable Malicious Tag or an Unremovable Malicious Tag

With reference to FIG. 2A, in response to determining that the first token request 126 includes the malicious tag 126a, processor 134 determines if the malicious tag 126a is a removable malicious tag or an unremovable malicious tag.

With reference to FIG. 2A, a removable malicious tag is that tag within the first token request 126 that is not essential or not mandatory to authenticate the NFC interaction 124. For example, the device identifier in tag 126a and the operating system identifier in tag 126n within the first token request 126 are removable tags as they are not essential to authenticate the NFC interaction 124. For example, when there is malicious code 136 injected within removable tags, for example, device identifier in tag 126a, then tag 126a is referred to as a removable malicious tag. When it is determined that the malicious tag 126a is a removable malicious tag, then the processor 134 executes and modifies the first token request 126 by removing the malicious tag 126a (e.g., by deleting the malicious code 136 and the device identifier data “Phone A1”) from the first token request 126 to generate a first sanitized token request 138 (represented in FIG. 2B) without the malicious tag 126a. The first sanitized token request 138 is also interchangeably referred to as modified token request 138. The server device 114 then approves/authenticates the NFC interaction 124 based on the first sanitized token request 138 without the malicious code 136.

In another embodiment, when the malicious code 136 is injected within the malicious tag 126a, processor 134 only removes the malicious code 136 from the malicious tag 126a such that the device identifier associated with the malicious tag 126a is not affected. Processor 134 then generates the first sanitized token request 138 with the tag 126a, such that the tag 126a does not include the malicious code 136.

Accordingly, the disclosed system provides a technical improvement in modifying a token request by eliminating a malicious tag 126a by accessing the existing indicators of attack 120. Accordingly, the disclosed system provides a practical application and technical improvement for proactively detecting malicious tag 126a and eliminating malicious attack before an attack. Thus, saving downtime associated with the affected servers and additionally saving resources that would otherwise be necessary to remediate affected server device 114, which in turn allows uninterrupted wireless interactions 124. In contrast, the current malicious attack detection techniques rely on system failure reports to detect the malicious attack after the attack. Thus, the current malicious attack detection techniques are not configured to detect malicious attacks before or during an attack.

In another embodiment, FIG. 2C when the first token request 126 includes a malicious code 136 within an unremovable tag (e.g., tag 126c, including terminal identifier TM1). An unremovable tag is that tag within the first token request 126, which is essential or mandatory to authenticate the NFC interaction 124. For example, the terminal identifier in tag 126c and the card number in tag 126b within the first token request 126 are unremovable tags as they are essential to authenticate the NFC interaction 124. For example, when there is malicious code 136 injected within a tag 126c (i.e., tag 126c is determined as a malicious tag), then since the terminal identifier (e.g., TM1) is essential or mandatory to authenticate the NFC interaction 124, tag 126c is determined as an unremovable malicious tag 126c. Further, when it is determined that the malicious tag 126c is an unremovable malicious tag, then the server device 114 denies authentication of the NFC interaction 124.

### Including Tags in AI-Determined Indicators of Attack

The stored AI-determined indicators of attack 122 include a list of removable malicious tags that the system 100 has identified as part of authenticating the wireless interaction 124. FIG. 3B shows an example of AI-determined indicators of attack 122.

With reference to FIGS. 2A and 3B, upon removing the malicious tag 126a from the first token request 126 to generate a first sanitized token request 138 without the malicious tag 126a (as explained above), processor 134 executes the generative AI model 130 to include/store the malicious tag 126a in a list of AI-determined indicators of attack 122. For example, FIG. 3B shows a list of AI-determined indicators of attack 122, which includes the removable malicious tag 126a with the device identifier (Phone A1) and malicious code 136. Upon including the malicious tag 126a in a list of AI-determined indicators of attack 122, the NFC interaction 124 is approved based on the first sanitized token request 138.

The stored AI-determined indicators of attack 122 include a list of unremovable malicious tags that the system 100 has identified as part of authenticating the wireless interaction 124. FIG. 3B shows an example of AI-determined indicators of attack 122.

With reference to FIGS. 2C and 3B, when it is determined that the malicious tag 126c is an unremovable malicious tag, then the server device 114 denies authentication of the NFC interaction 124 (as explained above). Further, before denying the authentication of the NFC interaction 124, processor 134 executes the generative AI model 130 to include/store the malicious tag 126c in a list of AI-determined indicators of attack 122. For example, FIG. 3B shows a list of AI-determined indicators of attack 122, which includes the unremovable malicious tag 126c with the terminal identifier (TM1) and malicious code 136.

Apart from the unremovable malicious tag 126c, the remaining unremovable tags included in tags 126a to 126n (the first set of tags) are called accompanying tags. For example, apart from the unremovable malicious tag 126c, the remaining tags are 126a-126b and 126d-126n (a subset of the first set of tags). From the remaining tags 126a-126b and 126d-126n, processor 134 identifies tag 126b (included within the subset of the first set of tags), which includes card number “12345678” as an accompanying tag. Specifically, upon including the unremovable malicious tag 126c, processor 134 executes the generative AI model 130 to identify other unremovable tags (e.g., tag 126b that includes card number “12345678”) in the first token request 126. Upon identifying the other unremovable tag 126b, the unremovable malicious tag 126b with the card number “12345678” is stored in the AI-determined indicators of attack 122. These other unremovable tag (e.g., tag 126b) identified along with the unremovable malicious tag 126c are referred to as accompanying tag 126b in the AI-determined indicators of attack 122.

In another embodiment, also with reference to FIG. 2C, upon including the unremovable malicious tag 126c in the AI-determined indicators of attack 122, processor 134 executes the generative AI model 130 to identify both removable tags (e.g., tag 126a, tag 126n) and unremovable tags (126b) in the first token request 126 and both removable tags and unremovable tags are stored in the AI-determined indicators of attack 122.

### Quarantine Sector

Quarantine sector 132 is a memory sector created so that first token request 126 or any other token requests when received by server device 114 is stored in quarantine sector 132. Any request or file stored within in the quarantine sector 132 is not permitted or prevented from acting on data outside the quarantine sector 132. Thus, when first token request 126 is stored in quarantine sector 132, a malicious tag 126b within first token request 126, is isolated and cannot harm or attack the rest of the components outside the quarantine sector 132.

In an embodiment, when the server device 114 receives the first token request 126. Processor 134 of the server device 114 stores the received first token request 126 in a quarantine sector 132. Quarantine sector 132 is a memory sector created such that first token request 126, or any file stored in quarantine sector 132, is not permitted or prevented from acting on files outside the quarantine sector 132. For example, with reference to FIG. 2A, when malicious tag 126a within first token request 126 is isolated and stored in the quarantine sector 132, it cannot harm or attack the rest of the components outside the quarantine sector 132. In another embodiment, quarantine sector 132 may include the generative AI model 130, the AI algorithm 144, and the IOA database 118. Thus, processor 134 executes software instructions 140 to perform one or more operations described above associated with detecting malicious tags and generating the first sanitized token request 138 to eliminate malicious attacks, such that all of the operations are performed within the quarantine sector 132.

In another embodiment, quarantine sector 132 may include the generative AI model 130, the AI algorithm 144, and the IOA database 118 within it. Thus, processor 134 executes software instructions 140 to perform all operations of FIGS. 5 and 6 within the quarantine sector 132.

### AI-Determined Indicators of Attack to Authenticate a Second Token Request

AI-determined indicators of attack 122 are then utilized to identify malicious tags from other token requests received after the first token request 126. For example, a second token request 146 is generated in response to an interaction between user device 110-n and terminal device 110-n. Upon the server device, 114 receives the second token request 146, and processor 134 utilizes the AI-determined indicators of attack 122 to authenticate the wireless interaction 124 associated with the second token request 146.

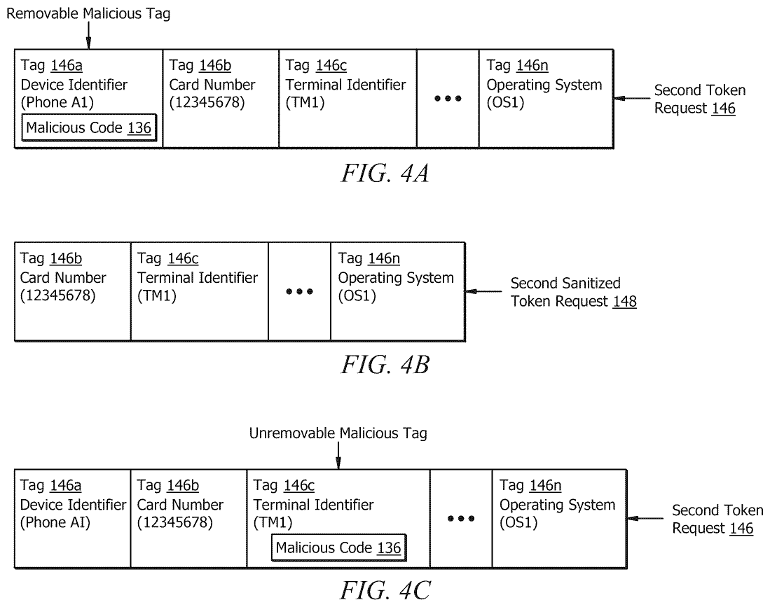

The processor 134 of the server device 114 receives a second token request 146 (FIG. 4A) for authentication in response to a wireless interaction 124 performed between user device 110-n and the terminal device 112-n. The processor 134 executes the generative AI model 130 to extract the tags 146a to 146n included within the second token request 148. The generative AI model 138 is trained based on the AI algorithm 144 (e.g., a Naïve Bayes classification algorithm) to extract tags included within the second token request 146.

Upon extracting the tags 146a to 146n included within the second token request 148, processor 134 of the server device 114 accesses the list of removable malicious tags in the AI-determined indicators of attack 122 of FIG. 3B to determine if at least one of the tags 146a to 146n in the second token request 146 matches any of the removable malicious tags stored in the list of AI-determined indicators of attack 122.

### When it is Determined the Second Token Request Includes a Removable Malicious Tag Then Generate a Second Sanitized Token Request

With reference to FIG. 4A, when the tag 146a of the second token request 146 matches the removable malicious tag 126a stored in the list of AI-determined indicators of attack 122 of FIG. 3B, the server device 114 modifies the second token request 146 by removing the malicious tag 146a from the second token request 146 to generate a second sanitized token request 148. For example, for tag 146a when a device identifier (e.g., Phone A1) and the malicious code 136 of the second token request 146, matches the device identifier (Phone A1) and the malicious code 136 of removable malicious tag 126a stored in the list of AI-determined indicators of attack 122 in FIG. 3B, then the server device 114 generates a second sanitized token request 148 (see FIG. 4B).

As seen in FIG. 4B the generated second sanitized token request 148 does not include the malicious tag 146a and includes the remaining tags 146a, 146c-146n. Once the second sanitized token request 148 is generated, processor 134 of the server device 114 determines if the tags 146a, 146c-146n in the second sanitized token request 148 include any other malicious tags based on the existing indicators of attack 120. The process of identifying a malicious tag based on the existing indicators of attack 120 is explained above.

When it is determined that the second token request 146 does not include a removable malicious tag that is stored in the list of AI-determined indicators of attack 122, then processor 134 of the server device 114 accesses the list of unremovable malicious tags stored in the list of AI-determined indicators of attack 122 of FIG. 3B and determines if the second token request 146 includes a tag that matches any of the unremovable malicious tags stored in the list of AI-determined indicators of attack 122.

With reference to FIG. 3B and FIG. 4C, when the tag 146c of the second token request 146 matches the unremovable malicious tag 126c stored in the list of AI-determined indicators of attack 122 in FIG. 3B, then it is determined that tag 146c is an unremovable malicious tag 146c. For example, when a terminal identifier (e.g., TM 1) 146c and the malicious code 136 of the second token request 146, matches the terminal identifier (TM1) and the malicious code 136 of unremovable malicious tag 126c stored in the list of AI-determined indicators of attack 122 in FIG. 3B, then it is determined that tag 146c is an unremovable malicious tag 126c.

Further, when it is determined that the second token request 146 does not include a tag that matches any of the unremovable malicious tags stored in the list of AI-determined indicators of attack 122, then the processor 134 of the server device 114 determines if the tags 146a, 146c-146n in the second sanitized token request 148 include any other malicious tags based on the existing indicators of attack 120. The process of identifying a malicious tag based on the existing indicators of attack 120 is explained above.

### Identify Accompanying Tags and Deny the Second Token Request

Apart from the unremovable malicious tag 146c, the remaining unremovable tags included in the tags 146a to 146n are called accompanying tags. Upon determining that tag 146c matches to an unremovable malicious tag 126c (FIG. 3B) then server device 114 determines if an accompanying tag (e.g., card number “12345678” of tag 126b) in FIG. 3B of the list of AI-determined indicators of attack 122 matches with the corresponding accompanying tag (e.g., card number “12345678” of tag 126b) of the second token request 146.

Upon determining that an accompanying tag (e.g., card number “12345678” of tag 126b) in FIG. 3B of the list of AI-determined indicators of attack 122 matches with the corresponding accompanying tag (e.g., card number “12345678” of tag 146b) of the second token request 146 processor 134 of server device 114 then denies the wireless interaction 124 associated with the second token request 146.

For example, when processor 134 of server device 114 determines that the content (e.g., card number “12345678”) of tag 126b and tag 146b do not match with each other, then server device 114 determines that the accompanying tag in the list of AI-determined indicators of attack 122 does not match the corresponding accompanying tag of the second token request 146. The server device 114 then proceeds to include accompanying tags in AI-determined indicators of attack as described above.

When the server device 114 determines that the second token request 146 includes a malicious tag 146a that matches the removable malicious tag 126a stored in the AI-determined indicators of attack, then the server device 114 removes the malicious tag 146a from the second token request 146 and generates a second sanitized token request 148. The server device 114 then approves/authenticates the wireless interaction 124 based on the second sanitized token request 148 without the malicious tag 146a. Accordingly, the disclosed system provides a technical improvement in modifying second token request 146 by eliminating a malicious tag 146a based on the AI-determined indicators of the attack 122. Accordingly, the disclosed system provides a practical application and technical improvement for prompt detection of malicious tags 146a and early mitigation of malicious attacks to approve/authenticate wireless interactions 124 associated with the second token request 146 over current malicious attack detection techniques that are not configured to detect malicious code 136 before or during an attack, and that cannot eliminate the malicious code 136 within the second token request.

### Second Token Request in Quarantine Sector

In an embodiment, when the server device 114 receives the second token request 146. Processor 134 of the server device 114 stores the received second token request 146 in a quarantine sector 132. Quarantine sector 132 is a memory sector created such that second token request 146, or any file stored in quarantine sector 132, is not permitted or prevented from acting on files outside the quarantine sector 132. For example, with reference to FIG. 4A, when malicious tag 146a within a second token request 146 is isolated and stored in the quarantine sector 132, it cannot harm or attack the rest of the components outside the quarantine sector 132. In another embodiment, quarantine sector 132 may include the generative AI model 130, the AI algorithm 144, and the IOA database 118. Thus, processor 134 executes software instructions 140 to perform one or more operations described above associated with detecting malicious tags and generating the second sanitized token request 148 request to eliminate malicious attacks, such that all of the operations are performed within the quarantine sector 132.

In another embodiment, quarantine sector 132 may include the generative AI model 130, the AI algorithm 144, and the IOA database 118 within it. Thus, processor 134 executes software instructions 140 to perform all operations of FIGS. 5 and 6 within the quarantine sector 132.

### Example Methods for Detecting Malicious Tags and Eliminating Malicious Attacks

FIG. 5 illustrates an example flowchart of method 500 for detecting malicious tags based on existing indicators of attack 120 and eliminating malicious attacks in accordance with an embodiment of the present disclosure. Further, method 500 generates AI-determined indicators of attack 122, which are utilized in FIG. 6. FIG. 6 illustrates an example flowchart of method 600 for detecting malicious tags based on AI-determined indicators of attack 122 (included as part of operations of FIG. 5) and eliminating malicious attacks in accordance with an embodiment of the present disclosure.

For example, one or more operations of methods 500 and 600 may be implemented, at least in part, in the form of software instructions 140 of FIG. 1, stored on a tangible non-transitory machine-readable medium (e.g., memory 128 of FIG. 1) that, when run by one or more processors (e.g., processor 134 of FIG. 1) may cause the one or more processors to perform operations of the methods 500 and 600.

### Example Method 500

Referring to FIG. 5, at operation 502, processor 134 of the server device 114 receives a first token request 126.

At operation 504, processor 134 of the server device 114 compares the extracted tags 126 a-126n of first token request 126 (see FIG. 2A) with a list of existing indicators of attack 120 (FIG. 3A) to determine if at least one of the received tags 126a-126n includes malicious code that at least partially matches with the example of the malicious code stored in the existing indicators of attack 120. For example, upon determining that a malicious code 136 matches the example malicious code 120a, then tag 126a is determined as a malicious tag 126a, and method 500 takes the Yes branch and proceeds to operation 508.

Back at operation 504, when processor 134 of the server device 114 determines the tags 126a-126n do not include a malicious tag based on the comparison, then the method 500 takes the No branch and proceeds to operation 506.

At operation 506, the processor 134 then approves/authenticates wireless interaction 124.

At operation 508, processor 134 of the server device 114 determines if the malicious tag is a removable malicious tag or an unremovable malicious tag. When it is determined that the malicious tag 126a is a removable malicious tag, then method 500 takes the Yes branch and proceeds to operation 510.

Further, when it is determined that the malicious tag 126c is an unremovable malicious tag, then method 500 takes the No branch and proceeds to operation 516.

At operation 510, processor 134 of the server device 114, modifies the first token request 126 by removing the malicious tag 126a from the first token request 126 to generate a first sanitized token request 138 (represented in FIG. 2B) without the malicious tag 126a. The method 500 then proceeds to operation 512.

At operation 512, processor 134 of the server device 114 includes/stores the malicious tag 126a in a list of AI-determined indicators of attack 122 (FIG. 3B). The method 400 proceeds to operation 514.

At operation 514, processor 134 of the server device 114, approves the wireless interaction 124 based on the first sanitized token request 138. The method 500 ends here.

Back at operation 508, when it is determined that malicious code 136 is injected within an unremovable malicious tag 126c (see FIG. 2C), method 500 takes the No branch and proceeds to operation 516.

At operation 516, with reference FIGS. 2C and 3B, processor 134 of the server device 114 includes/stores the malicious tag 126c in a list of AI-determined indicators of attack 122. The method 500 proceeds to operation 518.

At operation 518, processor 134 of the server device 114 identifies the unremovable malicious tag 126b with the card number “12345678” stored in the AI-determined indicators of attack 122. These other unremovable tag (e.g., tag 126b) identified along with the unremovable malicious tag 126c are referred to as accompanying tag 126b in the AI-determined indicators of attack 122. The method 500 proceeds to operation 520.

At operation 520, processor 134 of server device 114 then denies the wireless interaction 124. The method 500 ends here.

### Example Method 600

FIG. 6 illustrates an example flowchart of method 600 for detecting malicious tags based on AI-determined indicators of attack 122 (stored as part of the operation of FIG. 5) and eliminating malicious attacks in accordance with an embodiment of the present disclosure. FIG. 6 is explained with reference to FIG. 3B and FIGS. 4A-4C.

Referring to FIG. 6, at operation 602, processor 134 of the server device 114 receives a second token request 146. For example, server device 114 receives the second token request 146 generated in response to a wireless interaction 124 between user device 110-n and terminal device 112-n.

At operation 604, processor 134 of the server device 114 accesses the list of removable malicious tags (see FIG. 3B) stored in the list of AI-determined indicators of attack 122 during operation 512 of FIG. 5 determines if the second token request 146 includes a tag that matches any of the removable malicious tags stored in the list of AI-determined indicators of attack 122 represented in FIG. 3B.

With reference to FIG. 4A, when the tag 146a of the second token request 146 matches the removable malicious tag 126a stored in the list of AI-determined indicators of attack 122 during operation 512 of FIG. 5, then the method takes the Yes branch to operation 606.

For example, when a device identifier (e.g., Phone A1) and the malicious code 136 of the second token request 146, matches the device identifier (Phone A1) and the malicious code 136 of removable malicious tag 126a stored in the list of AI-determined indicators of attack 122 in FIG. 3B, then the method takes the Yes branch to operation 606. Here, the matching is performed based on both the device identifier and the malicious code 136.

In another embodiment, when it is determined that the second token request 146 includes a malicious code 136 that matches the malicious code 136 of removable malicious tag 126a stored in the list of AI-determined indicators of attack 122 in FIG. 3B, then the method takes the Yes branch to operation 606. Here, the matching is performed only for the malicious code 136 without the device identifier.

In yet another embodiment, when it is determined that the second token request 146 includes a device identifier (e.g., Phone A1) that matches the device identifier (Phone A1) of removable malicious tag 126a stored in the list of AI-determined indicators of attack 122 of FIG. 3B, then the method takes the Yes branch to operation 606. Here, the matching is performed only between the device identifiers without the malicious code 136.

At operation 606, processor 134 of the server device 114 modifies the second token request 146 by removing the malicious tag 146a from the second token request 146 to generate a second sanitized token request 148. As seen in FIG. 4B, the second sanitized token request 148 does not include the malicious tag 146a and includes the remaining tags 146a, 146c-146n. Once the second sanitized token request 148 is generated, method 600 then proceeds to operation 504 of FIG. 5. Such that the second sanitized token request 148 is processed at operation 504 to determine if it includes any other malicious tags based on the existing indicators of attack 120. The method proceeds as explained above from operation 504 of FIG. 5.

Back at operation 604, when it is determined that the second token request 146 does not include a removable malicious tag that is stored in the list of AI-determined indicators of attack 122, then method 600 takes the No branch and proceeds to operation 608.

At operation 608, processor 134 of the server device 114 accesses the list of unremovable malicious tags stored in the list of AI-determined indicators of attack 122 during operation 516 of FIG. 5 and determines if the second token request 146 includes a tag that matches any of the unremovable malicious tags stored in the list of AI-determined indicators of attack 122.

With reference to FIG. 3B and FIG. 4C, when the tag 146c of the second token request 146 matches the removable malicious tag 126c stored in the list of AI-determined indicators of attack 122 in FIG. 3B, then the method takes the Yes branch to operation 610.

For example, when a terminal identifier (e.g., TM1) 146c and the malicious code 136 of the second token request 146, matches the terminal identifier (TM1) and the malicious code 136 of removable malicious tag 126c stored in the list of AI-determined indicators of attack 122 in FIG. 3B, then the method takes the Yes branch to operation 610.

At operation 610, processor 134 of the server device 114 determines if an accompanying tag (e.g., tag 126b including card number “12345678”) in FIG. 3B of the list of AI-determined indicators of attack 122 matches with the corresponding accompanying tag (e.g., tag 146b) of the second token request 146. When it is determined that the content (e.g., card number “12345678”) of tag 126b and tag 146b match, then method 600 proceeds to operation 612.

At operation 612, processor 134 of server device 114 then denies the wireless interaction 124 associated with the second token request 146. The method 600 ends here.

Back at operation 610, when processor 134 of the server device 114 determines that the content (e.g., card number “12345678”) of tag 126b and tag 146b do not match with each other, then the method 600 takes the No branch and proceeds to operation 518 of FIG. 5.

Back at operation 608, when processor 134 of the server device 114 determines that the second token request 146 does not include a tag that matches any of the unremovable malicious tags stored in the list of AI-determined indicators of attack 122, then method 600 takes the No branch and proceeds to operation 504 of FIG. 5 and the method 600 ends.

In another embodiment, processor 134 may execute the generative AI model 130 to perform the operations of methods 500 and 600. Upon receiving the first token request 126, the processor 134 executes the generative AI model 130 to perform the operations of 502-520. Further, upon receiving the second token request 146, processor 134 executes the generative AI model 130 to perform the operations of 602-612.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory operable to store a generative artificial intelligence (AI) model, an indicator of attack (IOA) database, wherein the IOA database includes one or more existing indicators of attack and one or more AI-determined indicators of attack; and
a processor operably coupled to the memory and configured to:
receive a token request in response to an interaction initiated between a user device and a terminal device, wherein the token request comprises one or more tags, and each of the one or more tags provides information related to the interaction; and
execute the generative AI model to:
extract the one or more tags included within the token request;
compare the extracted one or more tags with the one or more existing indicators of attack stored in the IOA database;
based at least in part upon the comparison, determine whether the one or more tags included within the token request comprise a malicious tag;
in response to determining that the one or more tags included within the token request comprises a malicious tag, determine whether the malicious tag is a removable malicious tag or an unremovable malicious tag;
in response to determining that the malicious tag is a removable malicious tag, modify the token request to remove the malicious tag from the token request to generate a sanitized token request;
include the removable malicious tag in the one or more AI-determined indicators of attack stored in the IOA database; and
approve the sanitized token request.

2. The system of claim 1, wherein the processor is further configured to deny the token request in response to determining that the malicious tag is an unremovable malicious tag.

3. The system of claim 2, wherein the processor is further configured to:
receive a second token request, in response to a second interaction initiated between a second user device and the terminal device, wherein the second token request comprises a second set of two or more tags and the interaction is initiated over a near-field communication (NFC) channel; and
execute the generative AI model to:
extract the second set of two or more tags from the second token request;
compare the extracted second set of two or more tags with the one or more AI-determined indicators of attacks stored in the IOA database;
based at least in part upon the comparison, determine whether the second set of two or more tags included within the token request comprise a malicious tag;
in response to determining that the malicious tag is an unremovable malicious tag, identify one or more accompanying tags that are included in the token request, wherein the one or more accompanying tags is a subset of the second set of two or more tags;
include the identified one or more accompanying tags and the unremovable malicious tag in the one or more AI-determined indicators of attacks; and
deny the second token request.

4. The system of claim 1, wherein the processor is further configured to:
receive a second token request in response to a second interaction initiated between a third user device and the terminal device, wherein the second token request comprises a second set of one or more tags and the interaction is initiated over a near-field communication (NFC) channel; and
execute the generative AI model to:
extract the second set of one or more tags from the second token request;
compare the extracted second set of one or more tags with the one or more AI-determined indicators of attacks stored in the IOA database;
based at least in part upon the comparison, determine whether the second set of one or more tags included within the second token request includes a first tag that matches the removable malicious tag included in the one or more AI-determined indicators of attacks; and
in response to determining that the second set of one or more tags included within the second token request includes the first tag that matches the removable malicious tag, approve the token request.

5. The system of claim 3, wherein the processor is further configured to:
receive a third token request, in response to a third interaction initiated between a third user device and the terminal device, wherein the third token request comprises a third set of two or more tags; and
execute the generative AI model to:
extract the third set of two or more tags from the third token request;
compare the extracted third set of two or more tags with the one or more AI-determined indicators of attacks stored in the IOA database;
based at least in part upon the comparison, determine whether the third set of two or more tags included within the third token request includes a second tag that matches the unremovable malicious tag included in the one or more AI-determined indicators of attacks;
in response to determining that the third set of two or more tags within the third token request includes the second tag that matches the unremovable malicious tag, determine whether the third set of two or more tags includes the one or more accompanying tags; and
in response to determining that the third set of two or more tags includes the one or more accompanying tags, deny the token request.

6. The system of claim 1, wherein the processor is further configured to:
in response to determining that the one or more tags included within the token request comprise a malicious tag, determine whether the malicious tag is at least one of a terminal identifier or a card number; and
in response to determining that the malicious tag is at least one of a terminal identifier or a card number, determine that the malicious tag is the unremovable malicious tag.

7. The system of claim 1, wherein the processor is further configured to:
in response to determining that the one or more tags included within the token request comprise a malicious tag, determine whether the malicious tag is at least one of a device identifier, or an operating system identifier; and
in response to determining that the malicious tag is at least one of a device identifier, or an operating system identifier, determine that the malicious tag is a removable malicious tag.

8. A method comprising:
receiving a token request in response to an interaction initiated between a user device and a terminal device, wherein the token request comprises one or more tags, and each of the one or more tags provides information related to the interaction;
extracting the one or more tags included within the token request;
comparing the extracted one or more tags with one or more existing indicators of attack stored in an indicator of attack (IOA) database;
based at least in part upon the comparison, determining whether the one or more tags included within the token request comprise a malicious tag;
in response to determining that the one or more tags included within the token request comprises a malicious tag, determining whether the malicious tag is a removable malicious tag or an unremovable malicious tag;
in response to determining that the malicious tag is a removable malicious tag, modifying the token request to remove the malicious tag from the token request to generate a sanitized token request;
including the removable malicious tag in one or more AI-determined indicators of attack stored in the IOA database; and
approving the sanitized token request.

9. The method of claim 8, wherein the method further comprising denying the token request in response to determining that the malicious tag is an unremovable malicious tag.

10. The method of claim 9, further comprising:
receiving a second token request, in response to a second interaction initiated between a second user device and the terminal device, wherein the second token request comprises a second set of two or more tags and the interaction is initiated over a near-field communication (NFC) channel;
extracting the second set of two or more tags from the second token request;
comparing the extracted second set of two or more tags with the one or more AI-determined indicators of attacks stored in the IOA database;
based at least in part upon the comparison, determining whether the second set of two or more tags included within the token request comprise a malicious tag;
in response to determining that the malicious tag is an unremovable malicious tag, identifying one or more accompanying tags that are included in the token request, wherein the one or more accompanying tags is a subset of the second set of two or more tags;
including the identified one or more accompanying tags and the unremovable malicious tag in the one or more AI-determined indicators of attacks; and
denying the second token request.

11. The method of claim 8, further comprising:
receiving a second token request in response to a second interaction initiated between a third user device and the terminal device, wherein the second token request comprises a second set of one or more tags and the interaction is initiated over a near-field communication (NFC) channel;
extracting the second set of one or more tags from the second token request;
comparing the extracted second set of one or more tags with the one or more AI-determined indicators of attacks stored in the IOA database;
based at least in part upon the comparison, determining whether the second set of one or more tags included within the second token request includes a first tag that matches the removable malicious tag included in the one or more AI-determined indicators of attacks; and
in response to determining that the second set of one or more tags included within the second token request includes the first tag that matches the removable malicious tag, approving the token request.

12. The method of claim 10, further comprising:
receiving a third token request, in response to a third interaction initiated between a third user device and the terminal device, wherein the third token request comprises a third set of two or more tags;
extracting the third set of two or more tags from the third token request;
comparing the extracted third set of two or more tags with the one or more AI-determined indicators of attacks stored in the IOA database;
based at least in part upon the comparison, determining whether the third set of two or more tags included within the third token request includes a second tag that matches the unremovable malicious tag included in the one or more AI-determined indicators of attacks;
in response to determining that the third set of two or more tags within the third token request includes the second tag that matches the unremovable malicious tag, determining whether the third set of two or more tags includes the one or more accompanying tags; and
in response to determining that the third set of two or more tags includes the one or more accompanying tags, denying the token request.

13. The method of claim 8, further comprising:
in response to determining that the one or more tags included within the token request comprise a malicious tag, determining whether the malicious tag is at least one of a terminal identifier or a card number; and
in response to determining that the malicious tag is at least one of a terminal identifier or a card number, determining that the malicious tag is the unremovable malicious tag.

14. The method of claim 8, further comprising:
in response to determining that the one or more tags included within the token request comprise a malicious tag, determining whether the malicious tag is at least one of a device identifier, or an operating system identifier; and
in response to determining that the malicious tag is at least one of a device identifier, or an operating system identifier, determining that the malicious tag is a removable malicious tag.

15. A system comprising:
a memory operable to store an indicator of attack (IOA) database, wherein the IOA database includes one or more existing indicators of attack and one or more AI-determined indicators of attack; and
a processor operably coupled to the memory and configured to:
receive a token request in response to an interaction initiated between a user device and a terminal device, wherein the token request comprises one or more tags, and each of the one or more tags provides information related to the interaction;
extract the one or more tags included within the token request;
compare the extracted one or more tags with the one or more existing indicators of attack stored in the IOA database;
based at least in part upon the comparison, determine whether the one or more tags included within the token request comprise a malicious tag;
in response to determining that the one or more tags included within the token request comprises a malicious tag, determine whether the malicious tag is a removable malicious tag or an unremovable malicious tag;
in response to determining that the malicious tag is a removable malicious tag, modify the token request to remove the malicious tag from the token request to generate a sanitized token request;
include the removable malicious tag in the one or more AI-determined indicators of attack stored in the IOA database; and
approve the sanitized token request.

16. The system of claim 15, wherein the processor is further configured to deny the token request in response to determining that the malicious tag is an unremovable malicious tag.

17. The system of claim 16, wherein the processor is further configured to:
receive a second token request, in response to a second interaction initiated between a second user device and the terminal device, wherein the second token request comprises a second set of two or more tags and the interaction is initiated over a near-field communication (NFC) channel;
extract the second set of two or more tags from the second token request;
compare the extracted second set of two or more tags with the one or more AI-determined indicators of attacks stored in the IOA database;
based at least in part upon the comparison, determine whether the second set of two or more tags included within the token request comprise a malicious tag;
in response to determining that the malicious tag is an unremovable malicious tag, identify one or more accompanying tags that are included in the token request, wherein the one or more accompanying tags is a subset of the second set of two or more tags;
include the identified one or more accompanying tags and the unremovable malicious tag in the one or more AI-determined indicators of attacks; and
deny the second token request.

18. The system of claim 15, wherein the processor is further configured to:
receive a second token request in response to a second interaction initiated between a third user device and the terminal device, wherein the second token request comprises a second set of one or more tags and the interaction is initiated over a near-field communication (NFC) channel;
extract the second set of one or more tags from the second token request;
compare the extracted second set of one or more tags with the one or more AI-determined indicators of attacks stored in the IOA database;
based at least in part upon the comparison, determine whether the second set of one or more tags included within the second token request includes a first tag that matches the removable malicious tag included in the one or more AI-determined indicators of attacks; and
in response to determining that the second set of one or more tags included within the second token request includes the first tag that matches the removable malicious tag, approve the token request.

19. The system of claim 15, wherein the processor is further configured to:
in response to determining that the one or more tags included within the token request comprise a malicious tag, determine whether the malicious tag is at least one of a terminal identifier or a card number; and
in response to determining that the malicious tag is at least one of a terminal identifier or a card number, determine that the malicious tag is the unremovable malicious tag.

20. The system of claim 15, wherein the processor is further configured to:
in response to determining that the one or more tags included within the token request comprise a malicious tag, determine whether the malicious tag is at least one of a device identifier, or an operating system identifier; and
in response to determining that the malicious tag is at least one of a device identifier, or an operating system identifier, determine that the malicious tag is a removable malicious tag.
